(19) United States
(12) Patent Application Publication
(10) Pub. No.: US 2026/0112545 A1
(43) Pub. Date: Apr. 23, 2026

(54) SOLID ELECTROLYTIC CAPACITOR

(71) Applicant: TDK CORPORATION, Tokyo (JP)

(72) Inventors: Hideyuki KOBAYASHI, Tokyo (JP); Takaaki MORITA, Tokyo (JP); Tetsushi INOUE, Tokyo (JP)

(73) Assignee: TDK CORPORATION, Tokyo (JP)

(21) Appl. No.: 19/360,427

(22) Filed: Oct. 16, 2025

(30) Foreign Application Priority Data
Oct. 18, 2024 (JP) 2024-184474

(51) Int. Cl. H01G 9/048; H01G 9/045; H01G 9/15

(52) U.S. Cl. CPC H01G 9/048; H01G 9/045; H01G 9/15

(57) ABSTRACT

The solid electrolytic capacitor includes a solid electrolyte layer disposed between an anode electrode layer and a cathode electrode layer; a first side electrode in contact with a side surface of the anode electrode layer; a second side electrode in contact with a side surface of the cathode electrode layer; a first mixed region disposed on the anode electrode layer at the first side electrode side, and including a first metal and a first resin; and a second mixed region disposed between the first side electrode and the first mixed region, and including the first resin and a second metal different from the first metal.

### CROSS-REFERENCE TO RELATED APPLICATIONS

This application claims the benefit of priority to Japanese Patent Application No. 2024-184474, filed on October 18, 2024. The entire contents of the above-identified application are hereby incorporated by reference.

### TECHNICAL FIELD

The present disclosure relates to a solid electrolytic capacitor

### BACKGROUND

International Publication No 2019087692 discloses a solid electrolytic capacitor

### SUMMARY

A solid electrolytic capacitor with high resistance to environmental changes is desired.

A solid electrolytic capacitor of the present disclosure includes a solid electrolyte layer disposed between an anode electrode layer and a cathode electrode layer, a first side electrode in contact with a side surface of the anode electrode layer, a second side electrode in contact with a side surface of the cathode electrode layer, a first mixed region disposed on the anode electrode layer at the first side electrode side, and including a first metal and a first resin; and a second mixed region disposed between the first side electrode and the first mixed region, and including the first resin and a second metal different from the first metal.

According to the solid electrolytic capacitor of the present disclosure, resistance to environmental changes is enhanced.

### BRIEF DESCRIPTION OF THE DRAWINGS

FIG. 1 is a diagram illustrating a longitudinal cross-sectional configuration of a solid electrolytic capacitor.

FIG. 2 is a diagram illustrating a longitudinal cross-sectional configuration of a solid electrolytic capacitor element.

FIG. 3 is an enlarged view of a first region in a solid electrolytic capacitor element according to a first example.

FIG. 4 is a diagram for explaining a detailed structure within the first region according to the first example.

FIG. 5 is an enlarged view of a first region according to a second example.

FIG. 6 is a diagram for explaining a detailed structure within the first region according to the second example.

FIG. 7 is a chart showing experimental data.

FIG. 8 is a chart showing experimental data.

FIG. 9 is a chart showing experimental data.

FIG. 10 is a chart showing experimental data.

FIG. 11 is a chart showing experimental data.

FIG. 12 is a chart showing experimental data.

### DETAILED DESCRIPTION

Hereinafter, various exemplary embodiments will be described in detail with reference to the drawings. In each drawing, identical or corresponding parts are denoted by the same reference numerals, and redundant descriptions are omitted.

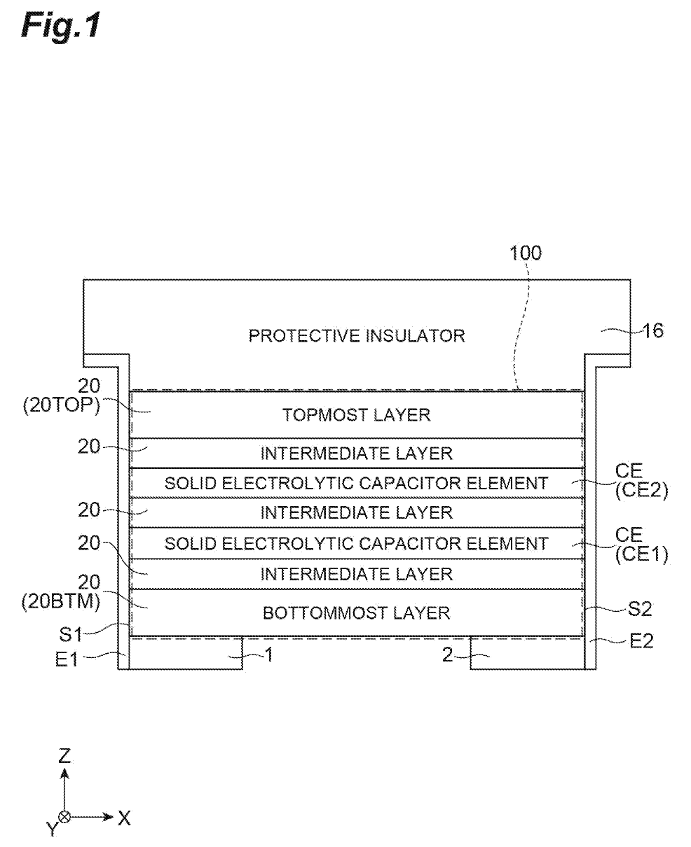

FIG. 1 is a diagram illustrating a longitudinal cross-sectional configuration of a solid electrolytic capacitor.

The solid electrolytic capacitor includes a bottommost layer 20BTM as a support substrate, a laminate 100 including the support substrate, and a protective insulator 16 provided on a top surface of the laminate 100 and on side surfaces where no electrodes are formed. The lower surface of the support substrate is provided with an anode terminal 1 and a cathode terminal 2. A first side electrode E1 electrically connected to the anode terminal 1 is provided on a first side surface S1 of the laminate 100. A second side electrode E2 electrically connected to the cathode terminal 2 is provided on a second side surface S2 of the laminate 100.

A three-dimensional orthogonal coordinate system is set. A stacking direction of solid electrolytic capacitor elements CE in the laminate 100 is defined as the Z-axis direction. An X-axis is perpendicular to the Z-axis and extends in a direction from the first side electrode E1 to the second side electrode E2. A Y-axis is perpendicular to the Z-axis and is also perpendicular to the X-axis. The first side surface S1 is one YZ plane of the laminate 100, and the second side surface S2 is the other YZ plane of the laminate 100.

The laminate 100 includes a plurality of solid electrolytic capacitor elements CE and a plurality of insulating layers (20). The plurality of insulating layers (20) includes the bottommost layer 20BTM (20), a topmost layer 20TOP (20), and one or more intermediate layers 20.

The bottommost layer 20BTM (20) constitutes the support substrate. The topmost layer 20TOP is disposed between the protective insulator 16 and an upper solid electrolytic capacitor element CE. The plurality of intermediate layers 20 includes an intermediate layer 20 disposed between the bottommost layer 20BTM and a lower solid electrolytic capacitor element, an intermediate layer 20 disposed between solid electrolytic capacitor elements CE adjacent in a thickness direction, and an intermediate layer 20 disposed between the topmost layer 20TOP and an upper solid electrolytic capacitor element CE.

The bottommost layer 20BTM increases the mechanical strength of the solid electrolytic capacitor and also functions as a barrier to protect internal layers from external contaminants. The topmost layer 20TOP increases the mechanical strength of the solid electrolytic capacitor and also functions as a barrier, together with the protective insulator 16, to protect internal layers from external contaminants. By providing the solid electrolytic capacitor with the bottommost layer 20BTM and the topmost layer 20TOP, stress generated inside the laminate due to environmental changes can be suppressed. Furthermore, by providing the solid electrolytic capacitor with one or more intermediate layers 20, stress generated inside the laminate due to environmental changes can be further suppressed.

In the figure, two solid electrolytic capacitor elements CE (a first solid electrolytic capacitor element CE1 and a second solid electrolytic capacitor element CE2) are shown. The number of solid electrolytic capacitor elements CE can be two or more, such as four or five. Even when the number of solid electrolytic capacitor elements CE increases, an intermediate layer 20 is disposed between solid electrolytic capacitor elements CE adjacent in the thickness direction.

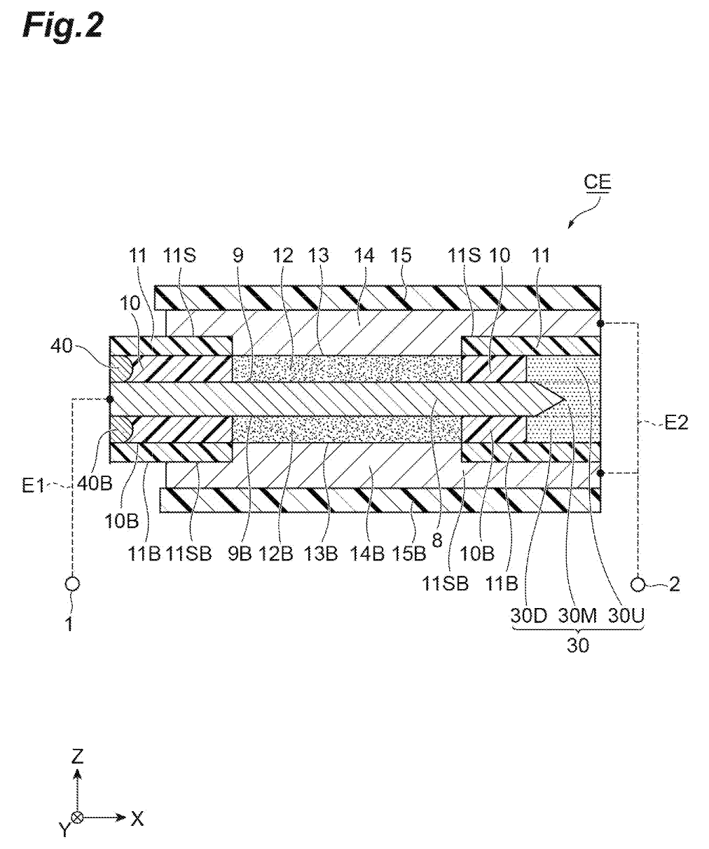

FIG. 2 is a diagram illustrating a longitudinal cross-sectional configuration of a solid electrolytic capacitor element CE.

One solid electrolytic capacitor element CE includes an anode electrode layer 8.

The solid electrolytic capacitor element CE includes, in an upper region of the anode electrode layer 8, an upper cathode electrode layer 14 and a solid electrolyte layer 12 disposed between the anode electrode layer 8 and the upper cathode electrode layer 14. The solid electrolyte layer 12 is composed of a roughened layer including a conductive polymer. In a region near the interface between the anode electrode layer 8 and the solid electrolyte layer 12, a dielectric layer 9 is formed along an irregular topography inside the roughened layer of the solid electrolyte layer 12. On an upper surface of the solid electrolyte layer 12, a residual conductive polymer layer that did not infiltrate the inside of the roughened layer during addition to the roughened layer may be formed, and a first conductive layer 13 is formed in contact with the conductive polymer layer. The first conductive layer 13 can be formed not only on the upper surface of the solid electrolyte layer 12 but also on an upper surface 11S of a pair of first insulating layers 11 formed at both ends in the X-axis direction of the solid electrolytic capacitor element CE. The upper cathode electrode layer 14 is formed on an upper surface of the first conductive layer 13. A first protective layer 15 is formed on an upper surface of the upper cathode electrode layer 14.

In the upper region of the anode electrode layer 8, in the vicinity of both ends in the X-axis direction, upper insulating regions 10 are formed as a pair of first mixed regions. One upper insulating region 10 is located in the vicinity of the first side electrode E1. The other upper insulating region 10 is located in the vicinity of the second side electrode E2. On an upper surface of each upper insulating region 10, the first insulating layer 11 is formed. On an upper surface of the first insulating layer 11, the upper cathode electrode layer 14 is formed. The material of the pair of upper insulating regions 10 includes a first metal and a first resin. The first metal is aluminum constituting the roughened layer, and the first resin is a thermosetting resin such as an epoxy resin.

The solid electrolytic capacitor element CE includes, in a lower region of the anode electrode layer 8, a lower cathode electrode layer 14B and a second solid electrolyte layer 12B disposed between the anode electrode layer 8 and the lower cathode electrode layer 14B. The second solid electrolyte layer 12B is composed of a roughened layer including a conductive polymer. In a region near the interface between the anode electrode layer 8 and the second solid electrolyte layer 12B, a second dielectric layer 9B is formed along an irregular topography inside the roughened layer of the second solid electrolyte layer 12B. On a lower surface of the second solid electrolyte layer 12B, a residual conductive polymer layer that did not infiltrate the inside of the roughened layer during addition to the roughened layer may be formed, and a second conductive layer 13B is formed in contact with the conductive polymer layer. The second conductive layer 13B can be formed not only on the lower surface of the solid electrolyte layer 12B but also on a lower second surface 11SB of a pair of second insulating layers 11B formed at both ends in the X-axis direction of the solid electrolytic capacitor element CE. The lower cathode electrode layer 14B is formed on a lower surface of the second conductive layer 13B. A second protective layer 15B is formed on a lower surface of the lower cathode electrode layer 14B.

In the lower region of the anode electrode layer 8, in the vicinity of both ends in the X-axis direction, lower insulating regions 10B are formed as a pair of first mixed regions. One lower insulating region 10B is located in the vicinity of the first side electrode E1. The other lower insulating region 10B is located in the vicinity of the second side electrode E2. On a lower surface of each lower insulating region 10B, the second insulating layer 11B is formed. On a lower surface of the second insulating layer 11B, the lower cathode electrode layer 14B is formed. The material of the pair of lower insulating regions 10B includes the above-mentioned first metal (roughened layer made of aluminum) and first resin (thermosetting resin such as epoxy resin).

The first side electrode E1 is in contact with one side surface of the anode electrode layer 8 and is electrically connected to the anode terminal 1. The first side electrode E1 is not in contact with one side surface of the upper cathode electrode layer 14. The second side electrode E2 is in contact with the other side surface of the upper cathode electrode layer 14 and is electrically connected to the cathode terminal 2. The second side electrode E2 is not in contact with the other side surface of the anode electrode layer 8, and an insulating portion 30 is interposed between the second side electrode E2 and the anode electrode layer 8.

The material of the insulating portion 30 includes the same material as the material of the protective insulator 16, and preferably includes a filler in a resin (e.g., epoxy resin). The insulating portion 30 has a three-layer structure of an upper layer 30U, an intermediate layer 30M, and a lower layer 30D. The insulating portion 30 may have a single-layer structure.

In an upper region on the first side electrode E1 side, an upper mixed region 40 (second mixed region) is disposed between the first side electrode E1 and the upper insulating region 10 (first mixed region) located adjacent thereto. In a lower region on the first side electrode E1 side, a lower mixed region 40B (second mixed region) is disposed between the first side electrode E1 and the lower insulating region 10B (first mixed region) located adjacent thereto.

An example of the material of the anode electrode layer 8 is aluminum. An example of the material of the roughened layer formed on the upper and lower surfaces of the anode electrode layer 8 is aluminum. An example of the material of the dielectric layer 9 formed near the surface of the anode electrode layer 8 is aluminum oxide (Al₂O₃). An example of the material of the solid electrolyte layer 12 is one in which a conductive polymer is introduced into a roughened layer of aluminum. An example of the material of the upper cathode electrode layer 14 is copper. The material of each element on the lower side of the anode electrode layer 8 is the same as the material of the corresponding element on the upper side.

The first mixed regions (insulating regions (10, 10B)) on the first side electrode side and the second side electrode side include a first metal (such as aluminum) and a first resin (a thermosetting resin such as epoxy resin). The insulating layers (11, 11B) on the first side electrode side and the second side electrode side include a filler such as silica and a resin (a thermosetting resin such as epoxy resin).

The second mixed region (40, 40B) is disposed between the first side electrode E1 and the first mixed region (insulating region (10, 10B)) and includes a second metal different from the first metal and the first resin. The second metal includes a metal contained in the side electrode, such as copper. The first resin is a thermosetting resin such as an epoxy resin, as described above.

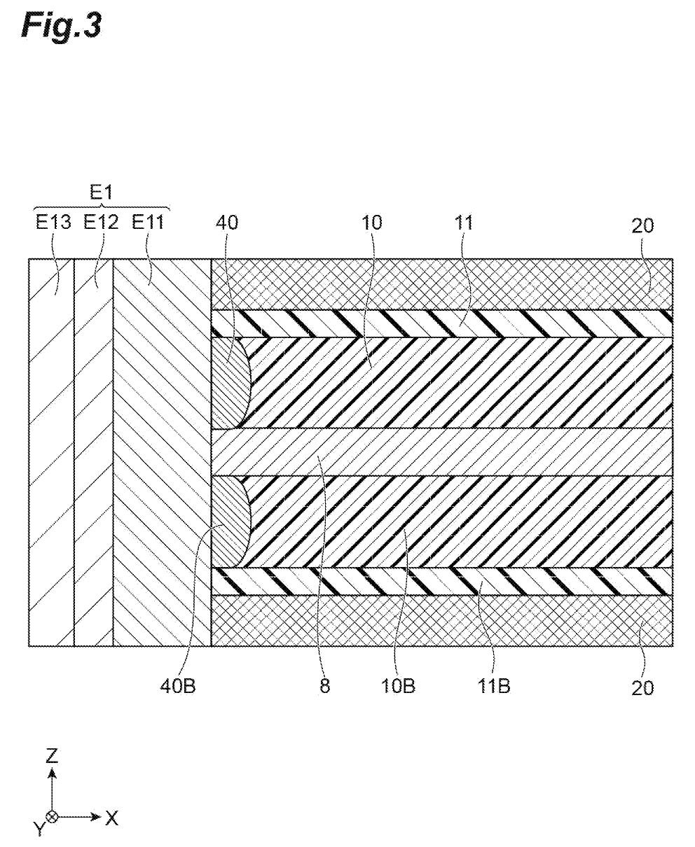

FIG. 3 is an enlarged view of a first region in a solid electrolytic capacitor element according to a first example. The first region is a region in the vicinity of the first side electrode E1.

In an upper region of the anode electrode layer 8, the upper insulating region 10 (first mixed region), the first insulating layer 11, and the intermediate layer 20 are sequentially stacked. Between the upper insulating region 10 and the first side electrode E1, the upper mixed region 40 (second mixed region) is formed. In a lower region of the anode electrode layer 8, the lower insulating region 10B (first mixed region), the second insulating layer 11B, and the intermediate layer 20 are sequentially stacked. Between the lower insulating region 10B and the first side electrode E1, the lower mixed region 40B (second mixed region) is formed.

The first side electrode E1 is made of a conductive material. The first side electrode E1 of this example includes a first electrode layer E11, a second electrode layer E12, and a third electrode layer E13, but may have a single-layer structure.

The first electrode layer E11 is made of a material with excellent electrical conductivity. A preferred example of the thickness of the first electrode layer E11 is 5 μm or more and 15 μm or less, and a more preferred example of the thickness is 8 μm or more and 12 μm or less. As the first electrode layer E11, a plating layer including a material with excellent conductivity, that is, copper (Cu) or silver (Ag), can be preferably used.

The second electrode layer E12 is an intermediate layer interposed between the first electrode layer E11 and the third electrode layer E13. The second electrode layer E12 has a role of preventing diffusion of Sn and the like contained in solder and the third electrode layer, and preventing oxidation of Cu and the like contained in the first electrode layer. As the material of the second electrode layer E12, Ni or the like, which is more resistant to oxidation than Cu and inhibits metal diffusion, can be used. If the second electrode layer E12 is too thin, its oxidation and diffusion prevention effect is weakened, and if it is too thick, the resistance value increases. A preferred example of the thickness of the second electrode layer E12 is 1 μm or more and 5 μm or less, and a more preferred example of the thickness is 2 μm or more and 4 μm or less. When the thickness is equal to or greater than the lower limit, the above-mentioned diffusion prevention effect is obtained, and when the thickness is equal to or less than the upper limit, an increase in the resistance value can be suppressed. Illustratively, this thickness is 3 μm. Preferably, nickel (Ni), which is a more stable material than copper (Cu), can be used as the second electrode layer E12.

The third electrode layer E13 is made of a conductive material that makes good contact with an externally provided Sn alloy (solder). As Sn alloys, Sn-Ag-Cu, Sn-Cu, Sn-Sb, Sn-Bi, and the like are known. The third electrode layer E13 can be composed of a metal with good wettability to a solder material (for example, an alloy such as Sn or SnAg). A preferred example of the thickness of the third electrode layer E13 is 3 μm or more and 7 μm or less, and a more preferred example of the thickness is 4 μm or more and 6 μm or less. When the thickness is equal to or greater than the lower limit, the influence of the underlying layer can be suppressed, and when the thickness is equal to or less than the upper limit, the material cost can be reduced. The third electrode layer E13 may be composed of a material including gold (Au) (e.g., Au), which has excellent conductivity and good wettability with solder. When gold is used, the effect can be obtained even if the thickness of the electrode layer is greater than 0 μm and 1 μm or less, and when the thickness is greater than 0 μm and 0.1 μm or less, the effect can be obtained while reducing the cost.

The structure and material of the second side electrode E2 can be the same as the structure and material of the first side electrode E1. The structure and material of the first side electrode E1 and the structure and material of the second side electrode E2 can also be different.

The second mixed region (40, 40B) is surrounded by the first electrode layer E11, the first insulating layer (11, 11B), the insulating region (10, 10B), and the anode electrode layer 8 in an XZ cross-section, and the metal material included in the first electrode layer E11 and the resin material included in the insulating region (10, 10B) are mixed.

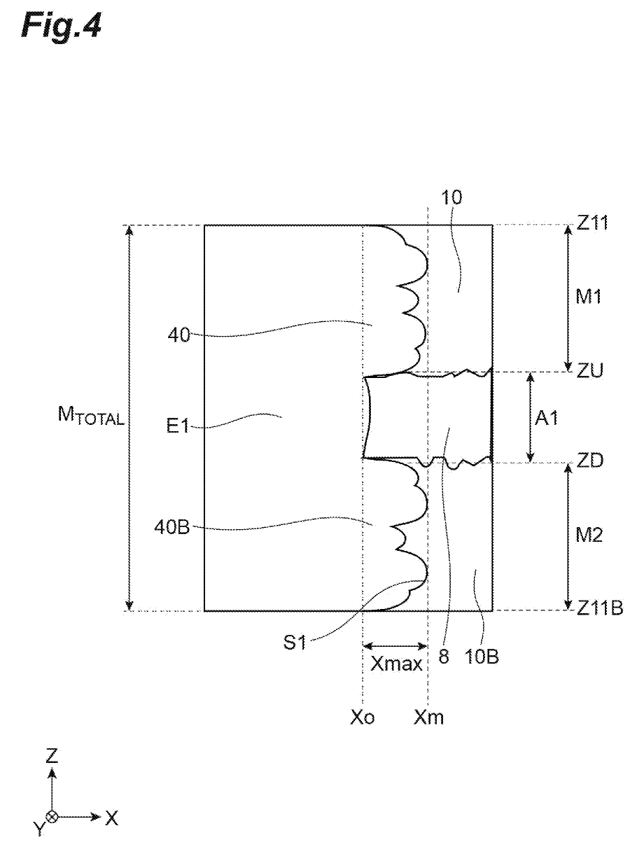

FIG. 4 is a diagram for explaining a detailed longitudinal cross-sectional structure within the first region according to the first example.

An interface between the anode electrode layer 8 and the upper insulating region 10 or the lower insulating region 10B is not a completely flat surface but has a fine irregular topography. The anode electrode layer 8 is not a roughened layer but is made of bulk metal. A first thickness A1 of the anode electrode layer 8 along the Z-axis direction can be defined by a distance between an upper position ZU of an upper surface (interface) of the anode electrode layer 8 and a lower position ZD of a lower surface (interface). The upper position ZU is a position in the Z-axis direction of a plane that fits a point group constituting the upper surface (interface) of the anode electrode layer 8, and can be determined by a least squares method that minimizes the distance between the point group and the plane. The lower position ZD is a position in the Z-axis direction of a plane that fits a point group constituting the lower surface (interface) of the anode electrode layer 8, and can be determined by a least squares method that minimizes the distance between the point group and the plane. In other words, an average height position of the upper irregular topography can be taken as the upper position ZU, an average height position of the lower irregular topography can be taken as the lower position ZD, and the distance between them can be taken as the first thickness A1 of the anode electrode layer 8.

A shape of the upper mixed region 40 (second mixed region) in the XZ plane has a shape extending from the first side electrode E1 toward the upper insulating region 10. This is because the metal material (aluminum) contained on the first side electrode side of the upper insulating region 10 was removed by etching, and the same metal material as the first side electrode was infiltrated into the region where the metal material was removed and the resin material remained. By etching, a side surface of the anode electrode layer 8 is etched, and in the XZ cross-section, the side surface is slightly recessed in the X-axis direction from a reference position Xo.

In the upper mixed region 40, a position farthest from the reference position Xo along the X-axis direction is a tip position Xm. A maximum dimension Xmax of the upper mixed region 40 in the X-axis direction is defined by Xmax = |Xm - Xo|.

Similarly, the lower mixed region 40B (second mixed region) in the XZ plane has a shape extending from the first side electrode E1 toward the lower insulating region 10B. In this example, the maximum dimension Xmax of the lower mixed region 40B in the X-axis direction is assumed to be the same as the maximum dimension Xmax of the upper mixed region 40 in the X-axis direction.

Since a structure above the anode electrode layer 8 and a structure below it are basically mirror-symmetric with respect to the anode electrode layer 8 and are the same, the thickness of the upper and lower insulating regions (10, 10B) is assumed to be equal to M1. A second thickness M1 of the upper insulating region 10 is defined between a position Z11 of an interface between the upper insulating region 10 and the first insulating layer 11 and the upper position ZU of an interface between the upper insulating region 10 and the anode electrode layer 8. A thickness M2 of the lower insulating region 10B is the second thickness M1 and is defined between a position Z11B of an interface between the lower insulating region 10B and the second insulating layer 11B and the lower position ZD of an interface between the lower insulating region 10B and the anode electrode layer 8.

It is preferable that the first thickness A1, the second thickness M1 (= M2), and the maximum dimension Xmax have the following relationship.

The first thickness A1 of the anode electrode layer 8 can be set to 1 μm ≤ A1 ≤ 300 μm. A preferable exemplary range for the first thickness A1 is 10 μm ≤ A1 ≤ 110 μm.

The second thickness M1 of the insulating region (10, 10B), which is the first mixed region, can be set to 1 μm ≤ M1 ≤ 100 μm. A preferable exemplary range for the second thickness M1 is 20 μm ≤ M1 ≤ 60 μm. The thickness of each solid electrolyte layer (12, 12B) shown in FIG. 2 can be set to the second thickness M1 of the insulating region.

A maximum dimension Xmax of the second mixed region (40, 40B) along a longitudinal direction (X-axis direction) of the anode electrode layer 8 satisfies 1.0 (μm) ≤ β ≤ 5.0 (μm), where β = Xmax / M1 × A1. If β is less than the lower limit, the effect of increasing the adhesion strength between the first side surface S1 of the laminate and the first side electrode E1 becomes weak, and even if it exceeds the upper limit, a significant increase in adhesion strength cannot be expected, and moisture tends to remain between the first mixed region and the second mixed region, leading to product destruction due to bumping of water in a reflow process.

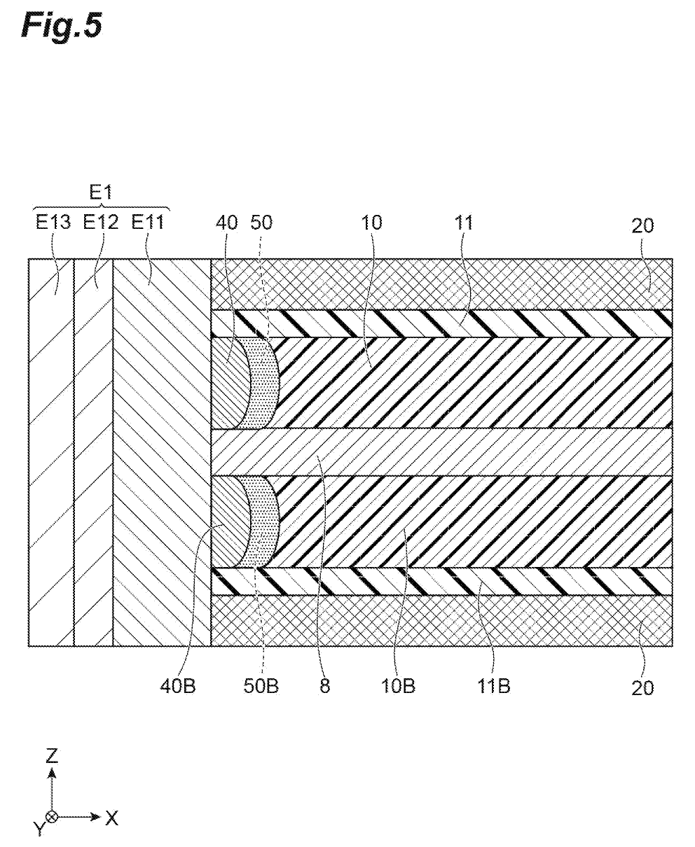

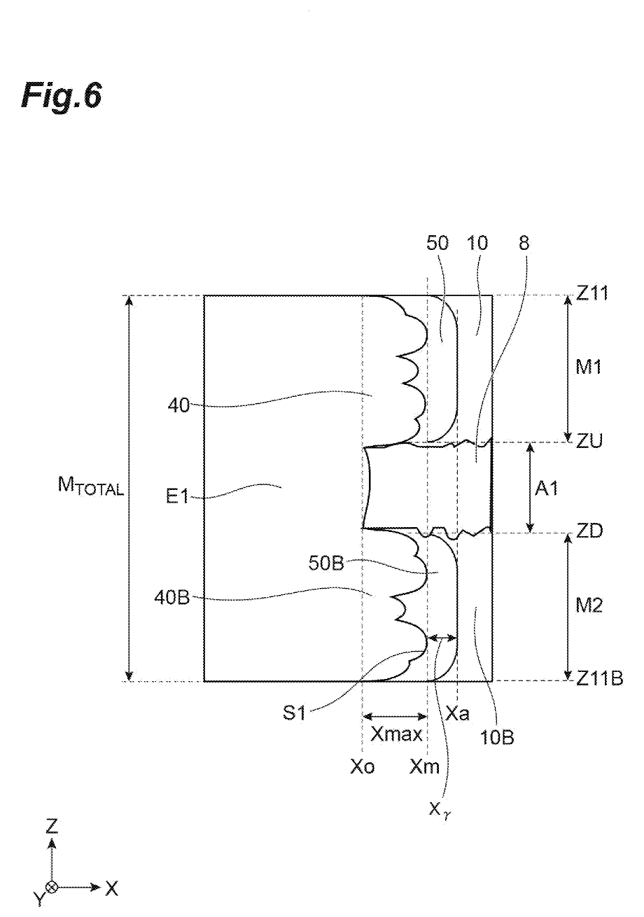

FIG. 5 is an enlarged view of a first region according to a second example. FIG. 6 is a diagram for explaining a detailed structure within the first region according to the second example.

The difference between the structure of the second example and the structure of the first example shown in FIGS. 3 and 4 is that an upper third mixed region 50 is provided between the upper insulating region 10 and the upper mixed region 40, and a lower third mixed region 50B is provided between the lower insulating region 10B and the lower mixed region 40B. Other structures of the second example are the same as the structure of the first example.

In the case of the structure of the first example, an interface between the first mixed region (10, 10B) and the second mixed region (40, 40B) has a three-dimensional irregular topography, and the contact area is large. This three-dimensional structure is more complex than the structure at the contact interface between an end face of an aluminum core (anode electrode layer 8) and the first side electrode E1, and its contact area is also large. Such a structure is useful for increasing adhesion strength. On the other hand, the solid electrolytic capacitor is subjected to heat during manufacturing or when mounted on a substrate. The solid electrolytic capacitor may also be placed in a high-humidity environment. In a high-temperature and high-humidity environment, the Kirkendall effect may occur, and the first metal and the second metal may diffuse into each other, causing the second metal to move from the region where it should originally exist and disappear from that region.

Therefore, in the structure of the second example, a diffusion barrier region for the metal material is provided. That is, a third mixed region (50, 50B) is provided between the first mixed region (10, 10B) and the second mixed region (40, 40B). The third mixed region (50, 50B) is a diffusion barrier region for the first metal and the second metal, and the diffusion coefficient of these metals is smaller than the diffusion coefficient in the first and second mixed regions. The third mixed region (50, 50B) includes the first resin (e.g., epoxy resin) and air (oxygen and nitrogen), and does not include the first metal (e.g., aluminum) and the second metal (e.g., copper). The third mixed region (50, 50B) has different properties from the first mixed region (10, 10B) and the second mixed region (40, 40B), and suppresses the diffusion of the first metal and the second metal. By including the third mixed region (50, 50B), the above-mentioned influence accompanying the diffusion can be suppressed. It is considered that the same effect can be obtained even if the third mixed region (50, 50B) includes the first resin (e.g., epoxy resin) and a gas containing at least nitrogen.

The maximum dimension Xmax of the second mixed region (40, 40B) along the longitudinal direction (X-axis) of the anode electrode layer 8 is a dimension between the reference position Xo and a first position (Xm) along the X-axis direction. In the third mixed region (50, 50B), a position farthest from the reference position Xo along the X-axis direction is a tip position Xa. A reference dimension Xγ of the third mixed region (50, 50B) is a dimension in the X-axis direction between a position (Xa) in the third mixed region and the first position (Xm) (Xγ = |Xa - Xm|). It is preferable that Xγ < Xmax is satisfied. When a Z-axis direction position giving the position (Xm) and a Z-axis direction position giving the position (Xa) coincide, the reference dimension Xγ can be a minimum dimension of the third mixed region in the X-axis direction (a shortest distance between the second mixed region (40, 40B) and the first mixed region (10, 10B)). Although it is preferable that the reference dimension (Xγ) in the X-axis direction of the third mixed region as a diffusion barrier region is smaller than the maximum dimension (Xmax) in the X-axis direction of the second mixed region that contributes to the improvement of adhesion strength, it may be larger as long as it can perform its function.

Next, materials and the like of each element constituting the solid electrolytic capacitor will be further described.

The number of solid electrolytic capacitor elements CE shown in FIG. 1 is assumed to be four. The thickness of each element in the laminate 100 is the dimension of each element in the stacking direction (Z-axis direction). Each of the intermediate layer 20, the topmost layer 20TOP, and the bottommost layer 20BTM includes a thermosetting resin (e.g., an epoxy) and may be provided as a prepreg incorporating glass cloth. The glass cloth can be a plain weave glass cloth, and fibers constituting the glass cloth extend along the X-axis direction and the Y-axis direction.

The protective insulator 16 is made of an insulating material. As the insulating material, inorganic insulating materials and organic insulating materials are known.

As inorganic insulating materials, silicon oxide (e.g., SiO₂), silicon nitride (e.g., SiNₓ), aluminum oxide (e.g., Al₂O₃), magnesium oxide (e.g., MgO), and the like are known. As organic insulating materials, thermosetting resins such as polyimide and epoxy resin are known. As a suitable insulating material for the protective insulator 16, an epoxy resin containing a filler is used in this example. Prior to thermosetting during manufacture, the protective insulator 16 may be in powder, liquid, granulated, or film form.

The bottommost layer 20BTM can constitute a support substrate. The structure of the bottommost layer 20BTM may be the same as the structure of the topmost layer 20TOP, but may also be a different structure. The bottommost layer 20BTM is made of an insulating material. As the insulating materials, the above-mentioned inorganic insulating materials and organic insulating materials are known. As insulating material substrates including an inorganic insulating material, glass substrates and LTCC (low-temperature co-fired ceramics) substrates including alumina and glass materials are known. As insulating material substrates including an organic insulating material, glass-epoxy substrates such as FR4 (Flame Retardant type 4) in which glass fiber (glass cloth or glass nonwoven fabric) is impregnated with epoxy resin and cured can also be used. As a suitable insulating material for the bottommost layer 20BTM, a glass-epoxy substrate is used in this example.

The anode terminal 1, the cathode terminal 2, the first side electrode E1, and the second side electrode E2 are composed of a metal material. An exemplary metal material is copper (Cu). A material (Sn) contained in solder may be included on the surface of the copper layer. These metal materials can include other elements.

The first side electrode E1 can include at least one conductive material (metal) selected from the group consisting of copper (Cu), nickel (Ni), tin (Sn), silver (Ag), gold (Au), platinum (Pt), palladium (Pd), indium (In), bismuth (Bi), and antimony (Sb). More specifically, the first side electrode E1 includes at least one conductive material selected from the group consisting of Cu, Ni, Sn, Ag, Au, Pd, Pt, Cu-Ni, Cu-Sn, Ni-Sn, Sn-Ag, Sn-In, Sn-Bi, Sn-Au, Sn-Sb, Sn-Pd, and pastes of these metal materials. The first side electrode E1 may be composed of a single layer, but may also be composed by stacking a plurality of conductive layers (metal layers) as described above. The materials of the anode terminal 1, the cathode terminal 2, and the second side electrode E2 can be set similarly to the material of the first side electrode E1.

The anode electrode layer 8 shown in FIG. 2 includes a first metal (aluminum). The insulating region (10, 10B) as the first mixed region and the solid electrolyte layer (12, 12B) also include the first metal (aluminum) as a roughened layer.

The material of the second mixed region (40, 40B) shown in FIG. 2 includes a second metal (e.g., Cu) different from the first metal and a first resin (e.g., epoxy resin) included in the insulating region (10, 10B). The second metal is a metal included in the first side electrode E1, and includes at least one conductive material (metal) selected from the group consisting of copper (Cu), nickel (Ni), silver (Ag), gold (Au), platinum (Pt), and palladium (Pd). Specifically, the second metal includes at least one conductive material (metal) selected from the group consisting of Cu, Ni, Ni-Cr, Ag, Au, Pt, and Pd.

The material of the dielectric layer (9, 9B) shown in FIG. 2 is, for example, aluminum oxide. The thickness of the dielectric layer (9, 9B) is, for example, 1 nm or more and 1 μm or less.

The conductive polymer (compound) included in the solid electrolyte layer (12, 12B) and its surface conductive polymer layer can include at least one selected from the group consisting of polypyrrole, polyaniline, polythiophene, polyfuran, and derivatives thereof. As the conductive polymer, poly(3,4-ethylenedioxythiophene) (PEDOT) and polypyrrole (PPy) are preferably used. These may be used alone or in a mixture of two or more. These materials can have excellent conductivity by adding an appropriate dopant.

The conductive layer (13, 13B) is, for example, composed of an adhesive conductive layer (e.g., carbon paste). The adhesive conductive layer includes a conductor and an adhesive. The conductor of the adhesive conductive layer is a material including carbon (e.g., graphite) or a metal. The adhesive of the adhesive conductive layer is a resin such as a phenolic resin, a urea resin, an epoxy resin, a polyester resin, or a polyimide resin, or a hydrocarbon compound such as paraffin oil. Carbon paste is a mixture of graphite powder and an adhesive, and can be used for the conductive layer (13, 13B). The conductive layer (13, 13B) can also be formed by a printing method.

As the metal conductive layer constituting the cathode electrode layer (14, 14B), copper (Cu), nickel (Ni), silver (Ag), tin (Sn), or the like can be used, and these metal conductive layers can be plating layers formed using a plating method. These metal conductive layers can also be formed by any method such as sputtering. When forming a plating layer by an electroless plating method, the underlying adhesive conductive layer can include a catalytic metal. The catalytic metal is a noble metal having catalytic activity for electroless plating, and palladium (palladium-based material), gold, platinum, rhodium, or the like can be used, with palladium being particularly preferably used. These may be used alone or in a mixture of two or more. An additional metal film may be formed (thickened) by an electrolytic plating method on a metal film formed by electroless plating or sputtering.

Generally, for copper plating, a copper sulfate bath, a pyrophosphate copper bath, a cyanide copper bath, a fluoborate copper bath, or the like can be used. For nickel plating, a Watts bath (nickel sulfate), a sulfamate bath (nickel sulfamate), an all-chloride bath (nickel chloride), or the like can be used. For tin plating, a sulfate bath, a sulfonate bath, or the like can be used. Various plating methods are known and can be applied to the formation of each plating layer.

The material of the insulating layer (11, 11B) includes the same first resin (e.g., epoxy resin) as the insulating region (10, 10B) and a filler. Basically, the filler does not penetrate into the insulating region (10, 10B). Therefore, the filler content in the insulating region (10, 10B) is smaller than the filler content in the insulating layer (11, 11B).

The protective layer (15, 15B) is made of a resist material including a resin, and preferably a material including a resin and an inorganic material. As the inorganic material, a filler such as silica (silicon oxide) can be used. As the resin material, a thermosetting resin such as polyimide or an epoxy resin can be used. In this example, a protective layer (15, 15B) in which silica is added to an epoxy resin is used. The resist material can be a liquid material dissolved in a suitable solvent during manufacturing. The protective layer (15, 15B) can be omitted.

As for the formation method of the protective layer (15, 15B), there are various methods. For example, a screen printing method or a gravure printing method (transfer) can be used. In this example, a screen printing method is used. The formation process of each element on the upper surface side and the formation process of each element on the lower surface side can be performed simultaneously or in different periods. Performing them simultaneously can shorten the manufacturing time.

The insulating portion 30 includes, at least in an upper layer and a lower layer, a constituent material (referred to as material A) included in the upper insulating region 10 and the lower insulating region 10B. The intermediate layer 30M of the insulating portion 30 mainly includes a constituent material (referred to as material B) of the protective insulator 16. The resin included in material A and the resin included in material B may be the same or different materials.

Material A is made of a resist material including a resin, and can include a filler of an inorganic material such as silica as needed. As this resin material, a thermosetting resin such as polyimide or an epoxy resin can be used. As an example of material A, an epoxy resin can be used.

Material B is made of a resin including a filler of an inorganic material such as silica. As this resin material, a thermosetting resin such as an epoxy resin can be used. As an example of material B, an epoxy resin containing a filler of silica can be used. The upper layer 30U and the lower layer 30D of the insulating portion 30 include an epoxy resin included in material A and material B, and as an example, the filler content is small. The intermediate layer 30M of the insulating portion 30 mainly includes material B, includes an epoxy resin and a filler, and as an example, the filler content is higher than that of the upper layer 30U and the lower layer 30D. As resins that can be included in material A and material B, phenolic resin, methacrylic resin, epoxy resin, silicone resin, polycarbonate, polyethylene terephthalate, polyamide, polyimide, polybutadiene, polyethylene, polystyrene, and the like can be exemplified. As inorganic materials constituting the filler, silica (SiO₂), aluminum oxide (Al₂O₃), aluminum nitride (AlN), and the like can be exemplified.

Next, a method of manufacturing a solid electrolytic capacitor will be briefly described.

First, a solid electrolytic capacitor sheet having a stacked structure of the solid electrolytic capacitor elements CE shown in FIG. 2 is manufactured. This sheet does not include the second mixed region (40, 40B) and the insulating portion 30, and these regions are filled with the same material as the insulating region (10, 10B). The method of manufacturing the solid electrolytic capacitor sheet includes (a) a metal sheet preparation process, (b) an insulating region formation process, (c) a solid electrolyte layer formation process, (d) a conductive layer formation process, (e) a cathode electrode layer formation process, (f) a protective layer formation process, and (g) a cathode electrode layer etching and dividing process, and these processes are executed sequentially.

(a) In the metal sheet preparation process, a metal sheet in which a roughened layer is formed on the upper and lower surfaces of the anode electrode layer 8 is prepared. The roughened layer is formed by first roughening both surfaces of the metal sheet by etching or the like, and then subjecting both surfaces of the metal sheet to a chemical conversion treatment (oxide film formation treatment and/or anodic oxidation) to form an oxide layer on these surfaces. A first dielectric layer (oxide layer: in this example, an Al₂O₃ layer) is formed on the upper surface of the anode electrode layer 8, and a second dielectric layer 9B (oxide layer: in this example, an Al₂O₃ layer) is formed on the lower surface.

(b) In the insulating region formation process, a resist (resin + filler) having a lattice pattern is applied onto the surface of the roughened layer to allow the resin to infiltrate into the roughened layer, thereby forming the insulating region (10, 10B). The filler does not infiltrate into the insulating region (10, 10B), but a resist including the filler remains on its surface to form the insulating layer (11, 11B). Various methods are known for applying the resist. For example, a screen printing method, a gravure printing method, a spray coating method, and the like are known. In this example, a screen printing method is used. The material of the resist is material A (e.g., a mixture of epoxy resin and silica filler). As fillers other than silica, alumina and aluminum hydroxide are known.

(c) In the solid electrolyte layer formation process, a conductive polymer is supplied into the openings of the lattice pattern and infiltrated into the roughened layer to form the solid electrolyte layer (12, 12B). Various methods are known for introducing the conductive polymer. For example, a coating method, a chemical oxidative polymerization method, an electrolytic polymerization method, and the like are known.

(d) In the conductive layer formation process, a conductive layer (13, 13B) is formed on the solid electrolyte layer (12, 12B). Each conductive layer may be a single layer, but may also be two or more layers. As a formation method, a method of applying a material of the conductive layer (e.g., carbon paste) can be used. A screen printing method, a gravure printing method (transfer), or a supply method using a dispenser can be used.

(e) In the cathode electrode layer formation process, a cathode electrode layer (14, 14B) is formed on the conductive layer (13, 13B) using a plating method or the like. When forming the cathode electrode layer, first, an underlying layer with high adhesion, such as copper (Cu) or nickel-chromium alloy (NiCr), is formed by a sputtering method, and a plating layer is formed on the underlying layer. The material of the plating layer in this example is copper (Cu).

(f) In the protective layer formation process, a protective film (15, 15B) made of a patterned resist is formed on the cathode electrode layer (14, 14B). For the formation of the protective layer, a screen printing method or a gravure printing method (transfer) can be used.

(g) In the cathode electrode layer etching and dividing process, using the protective film (15, 15B) as a mask, a part of the cathode electrode layer (14, 14B) is etched so that a part of the insulating layer (11, 11B) is exposed, and it is divided into a plurality of rectangular regions. As the etching solution, a ferric chloride aqueous solution, a cupric chloride aqueous solution, a mixed solution of sulfuric acid and hydrogen peroxide solution, or the like can be used. Through these processes, a solid electrolytic capacitor sheet is manufactured. The processing steps for the elements on the upper side of the anode electrode layer 8 and the processing steps for the elements on the lower side may be performed simultaneously or separately.

Next, a plurality of solid electrolytic capacitor sheets are stacked on the bottommost layer 20BTM as a support substrate shown in FIG. 1. An adhesive insulating layer (20) shown in the figure is disposed between each sheet, between the sheet and the support substrate, and on the topmost sheet. These sheet groups are bonded to manufacture a laminate sheet. A rotating blade is applied to the laminate sheet to form a groove along the Y-axis direction with the negative Z-axis direction as the depth direction. Similarly, a rotating blade is applied to the laminate sheet to form a groove along the X-axis direction with the negative Z-axis direction as the depth direction. An etching solution is introduced into the formed groove to etch both ends of the anode electrode layer 8, forming a space between a side surface portion of the anode electrode layer 8 and an initial inner surface of the groove. As the etching solution, an alkaline solution such as a sodium hydroxide aqueous solution or an acidic solution such as sulfuric acid can be used. An appropriate additive may be added to the etching solution as needed.

An insulating material constituting the protective insulator 16 is filled into the groove, and an insulating material is filled into the space between the side surface portion of the anode electrode layer 8 and the initial inner surface of the groove to form the insulating portion 30. In this filling process, an insulating resin is supplied to the upper surface of the laminate sheet, and pressure is applied in the Z-axis direction to fill the insulating resin into the groove and the space. The form of the supplied insulating resin may be liquid or a solid sheet. As a filling method, a compression molding method, a transfer molding method, or an injection molding method using a liquid insulating resin can be used. As a filling method, a method of attaching a sheet-like resin sealing material to the surface of the laminate sheet and planarization pressing the resin sealing material can also be used.

Next, a rotating blade is applied to the laminate sheet to form a groove along the Y-axis direction with the positive Z-axis direction as the depth direction, exposing one side surface on which the first side electrode E1 is to be formed and the other side surface on which the second side electrode E2 is to be formed. Thereafter, the same aluminum etching solution as above is introduced into the groove, and the exposed one side surface on which the first side electrode E1 is to be formed is lightly etched, and further, the first metal (aluminum) contained in the insulating region (10, 10B) adjacent to this side surface is dissolved, leaving a low-density resin in the region. A zincate treatment, which is generally used for surface treatment of aluminum, may be applied. Subsequently, the first side electrode E1 and the second side electrode E2 are formed on the inner surface of the groove by a plating method or the like, and the second mixed region (40, 40B) is formed by infiltrating the electrode material into the low-density resin. The formation position of the groove at this time is a position where the first side electrode E1 can contact one side surface of the anode electrode layer 8 and the second side electrode E2 can contact the other side surface of the cathode electrode layer (14, 14B). Finally, a rotating blade is applied to the laminate sheet to perform dicing in a lattice pattern, and individual solid electrolytic capacitors are individualized and cut out. The anode terminal 1 and the cathode terminal 2 can be formed by patterning an electrode material on the bottommost layer after stacking the solid electrolytic capacitor elements to form the laminate and before forming the side electrodes.

Since the solid electrolytic capacitors of the first and second examples described above include the second mixed region (40, 40B), the adhesion strength at the corresponding portion increases, and the environmental resistance to temperature changes and the like is enhanced. When the following environmental tests were performed on the solid electrolytic capacitors of the first and second examples, it was confirmed that the environmental resistance is enhanced by providing the solid electrolytic capacitor with the second mixed region (40, 40B). The details are as follows.

### [Experimental Conditions]

First, although the number of solid electrolytic capacitor elements CE shown in FIG. 1 is two, following the example of FIG. 1, the number of solid electrolytic capacitor elements CE was increased to four, and a solid electrolytic capacitor formed by stacking them was manufactured. The resin contained in the insulating layer (20) is an epoxy resin, and the glass yarn constituting the glass cloth is formed by bundling a plurality of filaments, and each filament is made of silica glass whose main component is SiO₂. An exemplary silica glass to be used is E-glass. As the material of the filament, glass including silica such as NE glass, or other known glass can be used.

The topmost layer 20TOP and the bottommost layer 20BTM include a resin and a glass cloth. This resin is an epoxy resin. This glass cloth has a plain weave woven structure composed of a plurality of glass yarns, and the thicknesses of the topmost layer 20TOP and the bottommost layer 20BTM are 150 (μm) and 200 (μm), respectively. The intermediate layer (20) includes an epoxy resin and a glass cloth, and has a thickness of 30 (μm).

The anode electrode layer 8 included in the solid electrolytic capacitor element is aluminum with a thickness (corresponding to A1) of 10 to 90 (μm), the dielectric layer (9, 9B) is aluminum oxide, and the solid electrolyte layer (12, 12B) is formed of PEDOT impregnated in an aluminum roughened layer with a thickness of 50 (μm).

The material of the conductive layer (13, 13B) is carbon paste, the cathode electrode layer (14, 14B) is copper (Cu) with a thickness of 10 (μm), and the protective layer 15 is a silica filler-containing epoxy resin (filler content = 40 (mass%)) with a thickness of 20 (μm).

The insulating region (10, 10B) is an aluminum roughened layer with a thickness (corresponding to M1, M2) of 20 to 50 (μm) containing an epoxy resin, the insulating layer (11, 11B) is a silica filler-containing epoxy resin (filler content = 60 (mass%)) with a thickness of 20 (μm), the upper and lower layers of the insulating portion 30 are each an epoxy resin with a thickness (M1, M2) of 20 to 50 (μm), and the intermediate layer of the insulating portion 30 is a filler-containing epoxy resin (filler content = 70 (mass%)) with a thickness (A1) of 10 to 90 (μm).

An aluminum sheet with roughened upper and lower surfaces is prepared, a resist including an epoxy resin and a silica filler is printed in a lattice pattern to form an insulating region (10, 10B) and an insulating layer (11, 11B), and PEDOT is infiltrated into the lattice openings to form a solid electrolyte layer (12, 12B). On top of that, an underlying layer of copper is formed by a sputtering method, and then copper plating is applied on the underlying layer to form a cathode electrode layer (14, 14B). Furthermore, a protective layer (15) serving as a resist is formed on top of that, a part of the protective layer is opened along the Y-axis direction, and the cathode electrode layer in the opening is etched.

Thereafter, four layers of sheets including the solid electrolytic capacitor elements created by these processes are prepared and stacked on a support substrate as a bottommost layer as shown in FIG. 1 to form a laminate sheet. A groove with the negative Z-axis direction as the depth direction was formed in this laminate sheet by applying a rotating blade to the laminate. After etching the anode electrode layer in this solid electrolytic capacitor intermediate, a filler-containing epoxy resin is filled into the groove. The laminate is covered with a protective insulator including a filler-containing epoxy resin. By forming side electrodes and electrode terminals and performing dicing for individualization, a solid electrolytic capacitor including four layers of solid electrolytic capacitor elements covered with a protective insulator, as shown in FIG. 1, is completed.

### [Evaluation and Results]

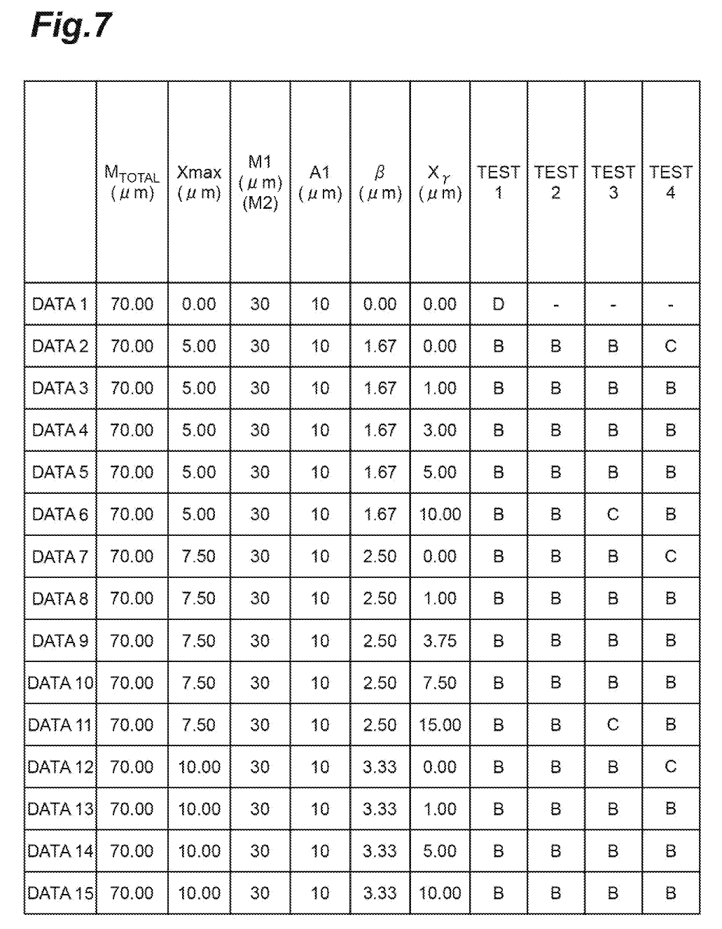

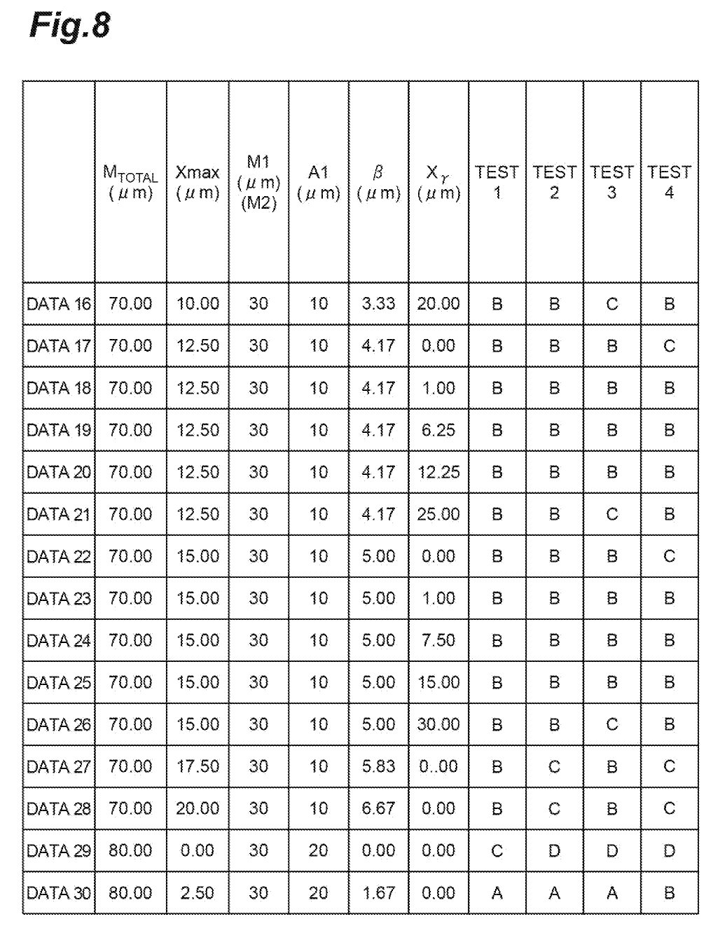

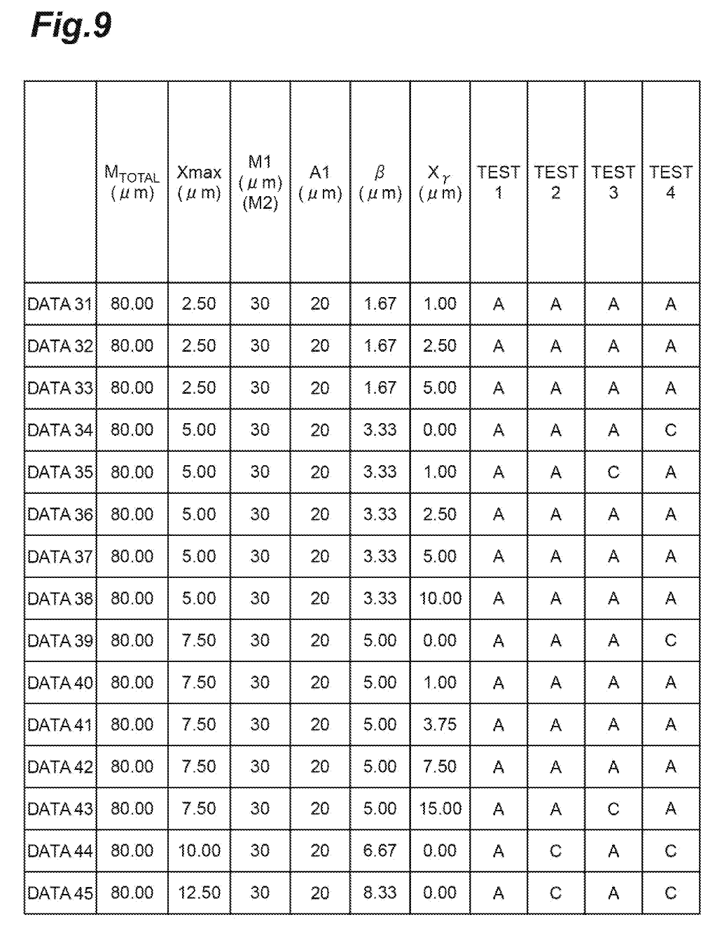

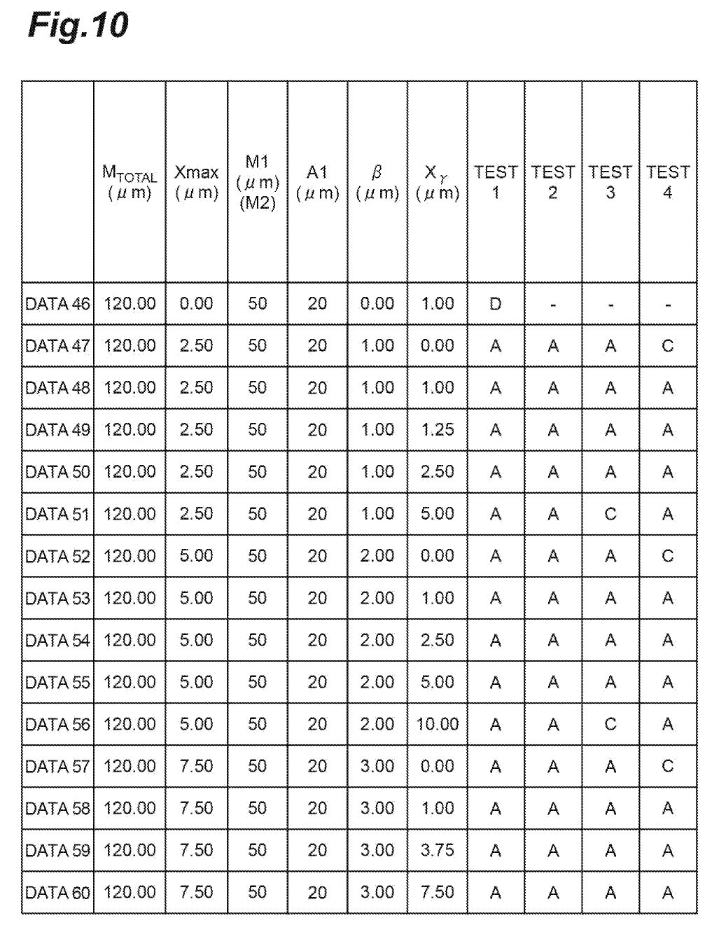

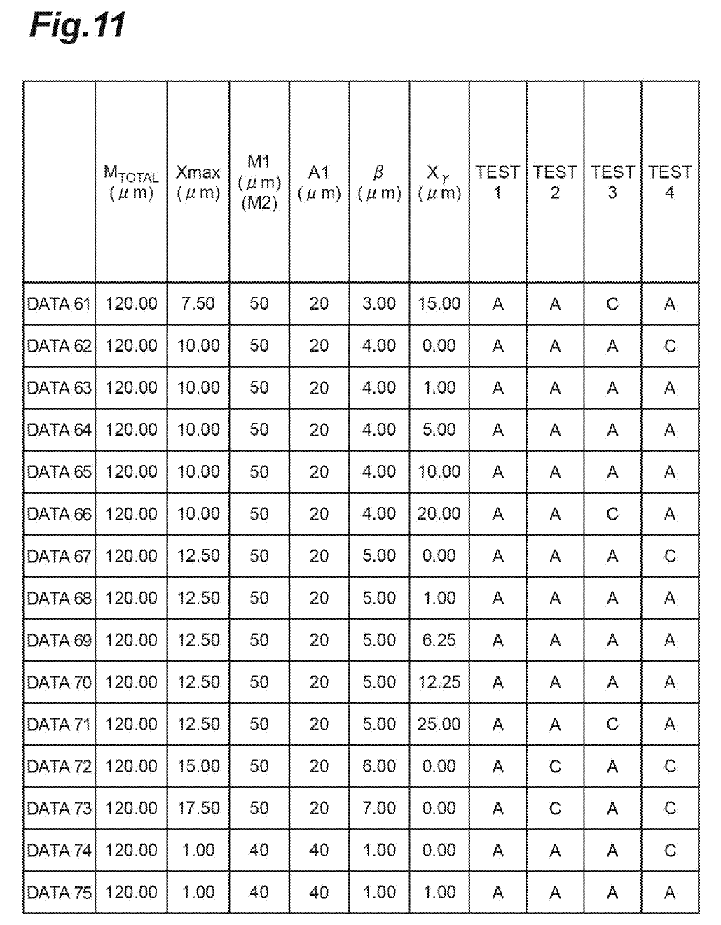

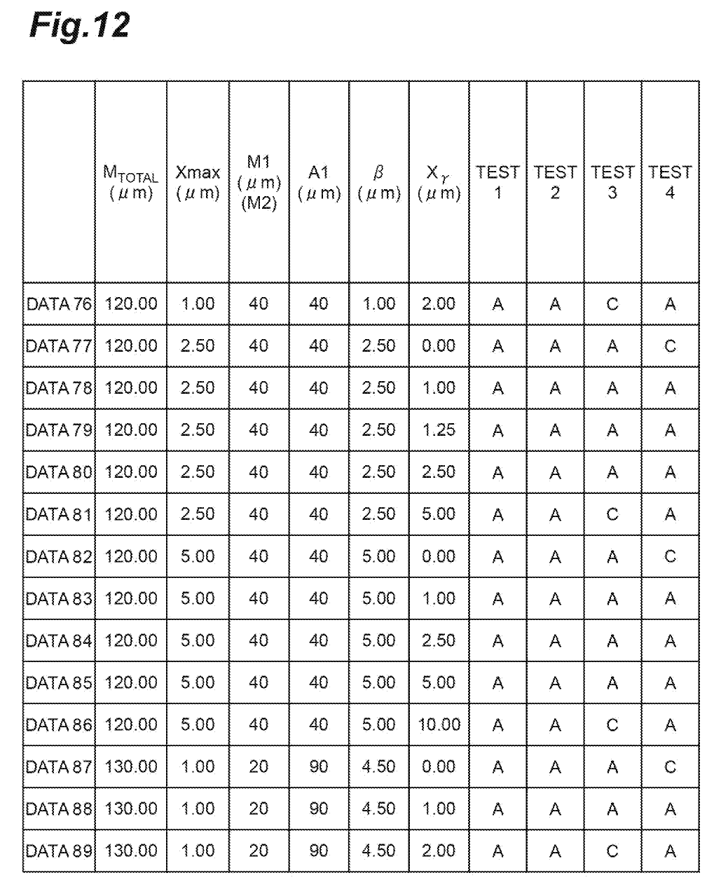

FIGS. 7, 8, 9, 10, 11, and 12 are charts showing experimental data of the solid electrolytic capacitor. The environmental resistance of solid electrolytic capacitors having a total thickness (M_{TOTAL} (μm) = M1 + M2 + A1) of the region including the anode electrode layer 8 and the insulating region (10, 10B), a maximum dimension (Xmax (μm)) of the second mixed region in the X-axis direction, a thickness (M1 (M2) (μm)) of one insulating region (10, 10B), a thickness (A1 (μm)) of the anode electrode layer 8, a parameter (β (μm) = Xmax / M1 × A1) related to the maximum thickness (Xmax (μm)), and a specific dimension (Xγ = Xa - Xm) of the third mixed region in the X-axis direction was evaluated. The thickness of each layer is determined by observation with an optical microscope. When the surface of each layer is rough and has irregularities, the thickness is determined using an average height position obtained by a least squares method for the surface height position. A hyphen in the charts means that the evaluation by the test could not be performed.

Test 1: Test 1 is a soldering test, and the adhesion strength of the solid electrolytic capacitor in its initial state was evaluated. The test is conducted in accordance with the "Adhesion Test Method for Plating" specified in Japanese Industrial Standard "JIS H 8504", with the soldering area changed to the product terminal size (area of the first side electrode). Test 1 was performed on n products (n = 11).

Test 2: Test 2 is a soldering test, and the adhesion strength of the solid electrolytic capacitor after undergoing a damp heat steady-state test in Test 1 is evaluated. In the damp heat steady-state test, the solid electrolytic capacitor is placed in an environment of a temperature of 85°C and a humidity of 85% RH for 2000 hours. Test 2 was performed on n products (n = 11).

The evaluation of Tests 1 and 2 is performed by visually checking whether the first side electrode (copper terminal) is attached to the jig side that was peeled off after soldering, and determining the state. If the first side electrode is attached to the peeled-off jig side, it can be determined that the adhesion strength is weak.

Rating A: In Tests 1 and 2, if the number of products with the first side electrode attached to the jig is 0, this solid electrolytic capacitor is evaluated as (Rating A) in Tests 1 and 2.

Rating B: In Tests 1 and 2, if the number of products with the first side electrode attached to the jig is 1, this solid electrolytic capacitor is evaluated as (Rating B) in Tests 1 and 2.

Rating C: In Tests 1 and 2, if the number of products with the first side electrode attached to the jig is 2, this solid electrolytic capacitor is evaluated as (Rating C) in Tests 1 and 2.

Rating D: In Tests 1 and 2, if the number of products with the first side electrode attached to the jig exceeds 2, this solid electrolytic capacitor is evaluated as (Rating D) in Tests 1 and 2.

Test 3: Test 3 is a soldering heat resistance test, in which a soldering heat resistance test (reflow method, in accordance with "Test methods for solderability, resistance to dissolution of metallization and to soldering heat of surface mounting devices (SMD)" specified in "JIS C 60068-2-58") was performed on the solid electrolytic capacitor in its initial state, and the presence or absence of delamination inside the product was evaluated. The longitudinal cross-section of the solid electrolytic capacitor was observed with an optical microscope, and the delamination state (disconnection) between the first side electrode and the anode electrode layer was observed. The maximum temperature in reflow was 260°C, and heating at the maximum temperature of 260°C for 30 seconds was performed three times. For easy observation of the longitudinal cross-section, the XZ plane of the completed solid electrolytic capacitor shown in FIG. 1 is polished to expose the first side electrode and the anode electrode layer, and observation is performed with a microscope. Test 3 was performed on n products (n = 11).

Rating A: In Test 3, if the number of products in which the above-mentioned delamination state was observed is 0, the solid electrolytic capacitor is evaluated as (Rating A) in Test 3.

Rating B: In Test 3, if the number of products in which the above-mentioned delamination state was observed is 1, the solid electrolytic capacitor is evaluated as (Rating B) in Test 3.

Rating C: In Test 3, if the number of products in which the above-mentioned delamination state was observed is 2, the solid electrolytic capacitor is evaluated as (Rating C) in Test 3.

Rating D: In Test 3, if the number of products in which the above-mentioned delamination state was observed exceeds 2, the solid electrolytic capacitor is evaluated as (Rating D) in Test 3.

Test 4: Test 4 is a high-temperature storage test, in which a test chip is placed in an environment at a temperature of 150°C for 2000 hours, and then the rate of change of the resistance value after this test, which applies a high-temperature environmental stress, with respect to the resistance value in the initial state is measured. The resistance value was measured between both terminal electrodes of the test chip with a micro-ohmmeter. The test chip is one in which the formation of the cathode electrode layer and the second side electrode in the solid electrolytic capacitor is omitted, and instead, a first side electrode that contacts the anode electrode layer is also provided on the second side electrode side, and the first side electrodes (both terminals) on both sides are short-circuited. Although the test chip is different from the completed solid electrolytic capacitor, since the influence of these environmental changes is considered to be similar, the environmental resistance of the solid electrolytic capacitor can also be indirectly evaluated by this test.

Rating A: In Test 4, if the resistance change rate is less than 5%, this solid electrolytic capacitor is evaluated as (Rating A) in Test 4.

Rating B: In Test 4, if the resistance change rate is 5% or more and less than 10%, this solid electrolytic capacitor is evaluated as (Rating B) in Test 4.

Rating C: In Test 4, if the resistance change rate is 10% or more and less than 20%, this solid electrolytic capacitor is evaluated as (Rating C) in Test 4.

Rating D: In Test 4, if the resistance change rate is 20% or more, this solid electrolytic capacitor is evaluated as (Rating D) in Test 4.

When the above-mentioned β (= Xmax / M1 × A1) is less than the lower limit (1.0 (μm)) (Data 1, Data 29), the expression of the anchoring effect is weak, and due to the initial decrease in adhesion strength, delamination is likely to occur between the first side electrode and the anode electrode layer. In at least Test 1, this product has a rating of C or lower.

When β exceeds the upper limit (5.0 (μm)) (Data 27, Data 28, Data 44, Data 45, Data 72, Data 73), the effect of improving the adhesion strength due to the expression of the anchoring effect between the first side electrode and the anode electrode layer reaches a plateau, so even if the value becomes larger, the initial adhesion strength does not increase any further. In addition, as the second mixed region expands, the metal diffusion of the first metal (e.g., aluminum) and the second metal (e.g., copper) becomes excessive in a high temperature and high humidity environment, and the disappearance of the second metal due to the Kirkendall effect occurs, which is considered to conversely decrease the adhesion strength. This product has a C rating in Test 2 and Test 4.

When β is in the range of 1 (μm) ≤ β ≤ 5 (μm), the rating of Test 1 is Rating A or Rating B, and the rating of Test 2 is Rating A or Rating B.

Furthermore, when the solid electrolytic capacitor includes the third mixed region (Data 3-6, 8-11, 13-16, 18-21, 23-26, 31-33, 35-38, 40-43, 47-51, 53-56, 58-61,63-66, 68-71, 75-76, 78-81, 83-86, 88-89), that is, when the reference dimension Xγ satisfies 1 (μm) ≤ Xγ ≤ 25 (μm), Rating A or Rating B is obtained in Test 4. Since the third mixed region includes at least nitrogen (air = nitrogen + oxygen), it can suppress the diffusion of metal elements between regions adjacent to the third mixed region. In this experiment, air was used, but it is possible to suppress metal diffusion as long as it contains at least nitrogen.

When β is in the range of 1 (μm) ≤ β ≤ 5 (μm) and the reference dimension Xγ satisfies Xγ ≤ Xmax, Rating A or Rating B is obtained in Tests 1 to 4.

When the reference dimension Xγ satisfies 3 (μm) ≤ Xγ ≤ 7.5 (μm), Rating A or Rating B is obtained in Test 3.

In the range of various parameters, when the range of an arbitrary parameter P is given by Pₘᵢₙ ≤ P ≤ Pₘₐₓ, it may be set to (Pₘᵢₙ + ΔP) ≤ P ≤ (Pₘₐₓ - ΔP), ΔP = (Pₘₐₓ - Pₘᵢₙ) × R%, and R may be set to R = 10, R = 20, R = 30, or R = 40. When an arbitrary parameter P is a specific single numerical value, its error range may be set to P × 95% ≤ P ≤ P × 105%.

As described above, the solid electrolytic capacitor of the first aspect includes a plurality of solid electrolytic capacitor elements (CE) stacked via an insulating layer (20), and each solid electrolytic capacitor element (CE) includes a solid electrolyte layer (12, 12B) disposed between an anode electrode layer 8 and a cathode electrode layer (14, 14B), a first side electrode E1 in contact with a side surface of the anode electrode layer 8, a second side electrode E2 in contact with a side surface of the cathode electrode layer (14, 14B), a first mixed region (insulating region (10, 10B)) disposed on the anode electrode layer 8 on the first side electrode (E1) side and including a first metal and a first resin, and a second mixed region (40, 40B) disposed between the first side electrode E1 and the first mixed region (insulating region (10, 10B)) and including a second metal different from the first metal and the first resin.

In the solid electrolytic capacitor of the second aspect, the anode electrode layer 8 includes aluminum, the first metal includes aluminum, the first side electrode E1 includes at least one conductive material selected from the group consisting of copper, nickel, tin, silver, gold, platinum, palladium, indium, bismuth, and antimony, and the second metal is a metal included in the first side electrode E1 and includes at least one conductive material selected from the group consisting of copper, nickel, silver, gold, platinum, and palladium.

In the solid electrolytic capacitor of the third aspect, the anode electrode layer 8 includes aluminum, the first metal includes aluminum, the first side electrode E1 includes copper, and the second metal includes copper.

In the solid electrolytic capacitor of the fourth aspect, the first resin includes a thermosetting resin.

In the solid electrolytic capacitor of the fifth aspect, a thickness M1 of the first mixed region (insulating region (10, 10B)), a thickness A1 of the anode electrode layer 8, and a maximum dimension Xmax of the second mixed region (40, 40B) along a longitudinal direction (X-axis) of the anode electrode layer 8 satisfy 1.0 (μm) ≤ β ≤ 5.0 (μm), where β = Xmax / M1 × A1.

The solid electrolytic capacitor of the sixth aspect includes a third mixed region (50, 50B) disposed between the first mixed region and the second mixed region, which suppresses diffusion of the first metal and the second metal.

The solid electrolytic capacitor of the seventh aspect includes a third mixed region (50, 50B) disposed between the first mixed region and the second mixed region, the third mixed region including the first resin and at least nitrogen.

In the solid electrolytic capacitor of the eighth aspect, the third mixed region (50, 50B) includes the first resin and at least nitrogen, and does not include the first metal and the second metal.

In the solid electrolytic capacitor of the ninth aspect, when a longitudinal direction of the anode electrode layer 8 is defined as an X-axis direction, a maximum dimension Xmax of the second mixed region (40, 40B) in the X-axis direction and a reference dimension Xγ of the third mixed region (50, 50B) in the X-axis direction satisfy Xγ ≤ Xmax, and the reference dimension Xγ is a distance (Xγ = |Xa - Xm|) between a position in the X-axis direction (Xm) that gives the maximum dimension Xmax of the second mixed region and a position (Xa) in the X-axis direction of the third mixed region that is farthest from the first side electrode E1.

In the solid electrolytic capacitor of the tenth aspect, the first side electrode E1 includes a plurality of stacked electrode layers.

In the solid electrolytic capacitor of the eleventh aspect, the first side electrode E1 includes a first electrode layer E11, a second electrode layer E12, and a third electrode layer E13, the first electrode layer E11 includes copper (Cu) or silver (Ag) and is in contact with the anode electrode layer 8, the second electrode layer E12 includes nickel (Ni) and is interposed between the first electrode layer E11 and the third electrode layer E13, and the third electrode layer E13 includes tin (Sn) or gold (Au).

In the solid electrolytic capacitor of the twelfth aspect, the second electrode layer E12 has a thickness of 1 μm or more and 5 μm or less.

In the solid electrolytic capacitor of the thirteenth aspect, the first electrode layer E11 has a thickness of 5 μm or more and 15 μm or less, and the second electrode layer E12 has a thickness of 1 μm or more and 5 μm or less.

In the solid electrolytic capacitor of the fourteenth aspect, the first electrode layer E11 has a thickness of 5 μm or more and 15 μm or less, the second electrode layer E12 has a thickness of 1 μm or more and 5 μm or less, and the third electrode layer E13 includes tin (Sn) and has a thickness of 3 μm or more and 7 μm or less.

In the solid electrolytic capacitor of the fifteenth aspect, the first electrode layer E11 has a thickness of 5 μm or more and 15 μm or less, the second electrode layer E12 has a thickness of 1 μm or more and 5 μm or less, and the third electrode layer E13 includes gold (Au) and has a thickness greater than 0 μm and 1 μm or less.

The solid electrolytic capacitor of the sixteenth aspect includes an insulating portion 30 interposed between the second side electrode E2 and a side surface of the anode electrode layer 8, the insulating portion 30 containing a resin and a filler, wherein an intermediate layer 30M located at a central portion in the thickness direction of the insulating portion 30 has a higher filler content than upper and lower layers 30U and 30D adjacent to the intermediate layer 30M.

The solid electrolytic capacitor of the seventeenth aspect further includes an insulating region (10, 10B) interposed between the anode electrode layer 8 and the insulating portion 30, and the insulating region includes the first metal and the first resin.

The solid electrolytic capacitor of the eighteenth aspect includes a dielectric layer 9 formed between the solid electrolyte layer 12 and the anode electrode layer 8, and the dielectric layer 9 includes an oxide of the first metal (e.g., aluminum) and has a thickness of 1 nm or more and 1 μm or less.

In the solid electrolytic capacitor of the nineteenth aspect, the reference dimension Xγ of the third mixed region in the X-axis direction is 1 μm or more and 25 μm or less.

In the solid electrolytic capacitor of the twentieth aspect, the reference dimension Xγ of the third mixed region in the X-axis direction is 3 μm or more and 7.5 μm or less.

In the solid electrolytic capacitor of the twenty-first aspect, further comprises an insulating layer disposed on the first mixed region and including a filler and a resin, and an intermediate layer disposed on the insulating layer and including a glass cloth and a resin.

It should be understood that not all aspects, advantages, and features described in this specification are necessarily achieved by or included in any particular embodiment. Indeed, although various embodiments are described and illustrated herein, it is clear that other embodiments may be modified in their configuration and details.

What is claimed is:

1. A solid electrolytic capacitor comprising:
a solid electrolyte layer disposed between an anode electrode layer and a cathode electrode layer;
a first side electrode in contact with a side surface of the anode electrode layer;
a second side electrode in contact with a side surface of the cathode electrode layer;
a first mixed region disposed on the anode electrode layer at the first side electrode side, and including a first metal and a first resin; and
a second mixed region disposed between the first side electrode and the first mixed region, and including the first resin and a second metal different from the first metal.

2. The solid electrolytic capacitor according to claim 1,
wherein
the anode electrode layer includes aluminum;
the first metal includes aluminum;
the first side electrode includes at least one conductive material selected from the group consisting of copper, nickel, tin, silver, gold, platinum, palladium, indium, bismuth, and antimony; and
the second metal is a metal included in the first side electrode, and includes at least one conductive material selected from the group consisting of copper, nickel, silver, gold, platinum, and palladium.

3. The solid electrolytic capacitor according to claim 1,
wherein
the anode electrode layer includes aluminum;
the first metal includes aluminum;
the first side electrode includes copper; and
the second metal includes copper.

4. The solid electrolytic capacitor according to claim 1,
wherein the first resin includes a thermosetting resin.

5. The solid electrolytic capacitor according to claim 1, wherein
a thickness M1 of the first mixed region;
a thickness A1 of the anode electrode layer; and
a maximum dimension Xmax of the second mixed region in a longitudinal direction of the anode electrode layer satisfy
1-51.0 μm ≤ β ≤ 5.0 μm,
where β = Xmax / M1 × A1.

6. The solid electrolytic capacitor according to claim 1, further comprising:
a third mixed region disposed between the first mixed region and the second mixed region, the third mixed region inhibiting diffusion of the first metal and the second metal.

7. The solid electrolytic capacitor according to claim 1, further comprising:
a third mixed region disposed between the first mixed region and the second mixed region, the third mixed region including the first resin and at least nitrogen.

8. The solid electrolytic capacitor according to claim 7, wherein
the third mixed region contains neither the first metal nor the second metal.

9. The solid electrolytic capacitor according to claim 7,
wherein, when a longitudinal direction of the anode electrode layer is defined as an X-axis direction,
a maximum dimension Xmax of the second mixed region in the X-axis direction and
a reference dimension Xγ of the third mixed region in the X-axis direction satisfy
Xγ ≤ Xmax; and
the reference dimension Xγ is a distance between a position along the X-axis at which the second mixed region attains its maximum dimension Xmax, and a position along the X-axis of the third mixed region that is farthest from the first side electrode.

10. The solid electrolytic capacitor according to claim 1,
wherein the first side electrode includes a plurality of stacked electrode layers.

11. The solid electrolytic capacitor according to claim 1,
wherein
the first side electrode includes:
a first electrode layer;
a second electrode layer; and
a third electrode layer;
the first electrode layer includes copper or silver, and is in contact with the anode electrode layer;
the second electrode layer includes nickel, and is interposed between the first electrode layer and the third electrode layer; and
the third electrode layer includes tin or gold.

12. The solid electrolytic capacitor according to claim 11,
wherein the second electrode layer has a thickness of 1 μm or more and 5 μm or less.

13. The solid electrolytic capacitor according to claim 11,
wherein
the first electrode layer has a thickness of 5 μm or more and 15 μm or less; and
the second electrode layer has a thickness of 1 μm or more and 5 μm or less.

14. The solid electrolytic capacitor according to claim 11,
wherein
the first electrode layer has a thickness of 5 μm or more and 15 μm or less;
the second electrode layer has a thickness of 1 μm or more and 5 μm or less; and
the third electrode layer includes tin and has a thickness of 3 μm or more and 7 μm or less.

15. The solid electrolytic capacitor according to claim 11,
wherein
the first electrode layer has a thickness of 5 μm or more and 15 μm or less;
the second electrode layer has a thickness of 1 μm or more and 5 μm or less; and
the third electrode layer includes gold, and has a thickness greater than 0 μm and 1 μm or less.

16. The solid electrolytic capacitor according to claim 1, further comprising an insulating portion disposed between the second side electrode and a side surface of the anode electrode layer, and including a resin and a filler,
wherein an intermediate layer located in a central part of the insulating portion in a thickness direction has a higher filler content than an upper layer and a lower layer adjacent to the intermediate layer.

17. The solid electrolytic capacitor according to claim 16, further comprising an insulating region disposed between the anode electrode layer and the insulating portion,
wherein the insulating region includes the first metal and the first resin.

18. The solid electrolytic capacitor according to claim 1, further comprising a dielectric layer formed between the solid electrolyte layer and the anode electrode layer,
wherein the dielectric layer includes an oxide of the first metal and has a thickness of 1 nm or more and 1 μm or less.

19. The solid electrolytic capacitor according to claim 1, further comprising:
an insulating layer disposed on the first mixed region, and including a filler and a resin; and
an intermediate layer disposed on the insulating layer, and including a glass cloth and a resin.
